(19) United States
(12) Patent Application Publication
(10) Pub. No.: US 2006/0213537 A1
(43) Pub. Date: Sep. 28, 2006

(54) Vertical wafer platform systems and methods for fast wafer cleaning and measurement

(75) Inventor: Edward Raymond Atalla, San Jose, CA (US)

Correspondence Address: Thu Anh To, 866 W. Rincon Ave., Campbell, CA, 95008, US

(73) Assignee: Thu Anh To

(21) Appl. No.: 11/089,278

(22) Filed: Mar. 23, 2005

(51) Int. Cl. B08B 7/04

(52) U.S. Cl. 134/18; 134/113; 134/137

(57) ABSTRACT

A multi-axis positioning system in a vertical wafer platform includes a measurement module in a semiconductor processing chamber, the measurement module having a focus position to collect data from the wafer; means for gripping a wafer at a wafer edge; and means for positioning the gripped wafer in a non-horizontal orientation at the focus position to allow access to one or both wafer surfaces.

The present invention relates generally to a positioning system and in particular to a semiconductor wafer platform.

Advances in semiconductor manufacturing have enabled the production of semiconductor wafers with sub-micron features formed thereon. Due to ever-shrinking device geometry, during manufacturing, wafers need to be cleaned to remove contaminant particles on the surfaces of the wafer. The contaminant particles can be caused by people, machine, process chemicals, or particle-shedding materials in the wafer-processing environment, among others. The cleaning of the wafer improves the quality of the devices formed thereon and reduces chances for defective devices. The wafer also needs to be inspected for defects on the surfaces of the wafer.

Commercially available wafer cleaning equipment use one or more known wet cleaning methods. In one method discussed in U.S. Pat. No. 5,849,135, the content of which is incorporated by reference, the wafer is submerged in a cleaning solution and the cleaning solution dissolves or breaks the particles off the surfaces of the wafer. In another method discussed in U.S. Pat. No. 6,082,377, the wafer is cleaned by a mechanical contact, such as a soft brush or a sponge, with the assist of some types of chemical solution. The brush or sponge wipes particles off the surfaces of the wafer. Another kind of machine is a vibrating wafer cleaner which removes particles from the surfaces of the wafer by vibrating the wafer inside an enclosure and passing a filtered air stream at the wafer to flush the particles out of the enclosure.

During fabrication, the wafers are also inspected for defects. Conventional equipment for wafer surface defect inspection typically holds the wafer horizontally. While horizontal orientation is stable, the machines cannot easily access both wafer surfaces at the same time or that its measurement environment is airborne particle controlled in case of wafer breakage.

U.S. Pat. No. 5,511,005 discloses a system for semiconductor wafer processing including wafer measurement and characterization having vertical wafer processing apparatus with which only the edge of a wafer is contacted. A wafer processing station is provided having a support bridge to which a rotor subassembly is attached. The rotor subassembly includes a housing and a rotor having a central aperture and a retention mechanism for retaining a wafer in a measurement position. A pair of pivotable probe arms includes one probe arm positioned on either side of the wafer. A sensor provides an image of a wafer prior to its retention by the retention mechanism in the measurement position in order to permit the retention mechanism to avoid any flat on the wafer.

U.S. Pat. No. 6,093,644 discloses a jig for semiconductor wafers whose surface is composed of the substrate of a high purity carbon is formed with a SiC film by the CVD method, said surface being ground by a grinding tool again formed of a SiC film. Hangover particles produced by said grinding operation are subjected to a high temperature oxydizing treatment to be dissolved thereafter.

### SUMMARY

In one aspect, a platform is provided that holds a wafer in any orientation with multi-axis positioning system to allow fast access of both flat wafer surfaces. In another aspect, a vertical wafer platform is used in a wafer cleaner to remove contaminated particles from wafer surfaces.

In another aspect, a multi-axis motion or any combination of the multi-axis positioning system in a vertical wafer platform includes a measurement module in a semiconductor processing chamber, the measurement module having a focus position of finite or infinite conjugate to collect data from the wafer; means for gripping a wafer at a wafer edge; and means for positioning the gripped wafer in a non-horizontal orientation at the focus position to allow access to one or both wafer surfaces.

Implementations of the above aspect can include one or more of the following. The multi-axis motion positioning system can be a six-axis system with six degrees of freedom, for example. The six degrees of freedom enable a wafer tray to rotate the wafer from the horizontal to the vertical position. The wafer within the wafer tray can be rotated for pre-alignment to find the wafer notch or to orient the wafer for vision processing in the theta axis in reference to the wafer tray. The wafer contained in the tray can be moved laterally inward, parallel to the measurement module(s). The wafer contained in the tray can be moved in the Z axis, upward. The wafer tray containing the wafer can be rotated 180 degrees within the lateral and Z axis stack. An additional feature is that the whole unit, all axis as a unit can be also rotated within the 360 degrees to have the desire wafer face to the desired measurement modules to allow for the 6 degrees of freedom for positioning to the measurement module. The wafer can also move perpendicular to the lateral positioning to allow for focusing to the measurement module.

The non-horizontal orientation can be a substantially vertical orientation. The wafer has a reference notch and the wafer is positioned for pre-alignment in reference to the reference notch. The wafer can be housed in a wafer holder. The wafer can be edge gripped using one of: mechanical, pneumatics, vacuum, and air mechanisms. The system can include means for cleaning a wafer, means for inspecting a wafer for surface defects, or means for accessing or processing one or more surfaces of the wafer. The means for gripping can be one or more edge gripping mounts. Both wafer surfaces are accessible to other devices in the processing chamber at the same time.

In another aspect, a multi-axis vertical wafer platform includes a processing module in a semiconductor processing chamber, the processing module having a focus position to process the wafer; one or more edge gripping mounts to grip a wafer edge; and a positioner to move the gripped wafer in a non-horizontal orientation to the focus position to allow access to one or both wafer surfaces.

In yet another aspect, a method for processing a wafer includes gripping an edge of the wafer and moving the wafer to a substantially vertical position; moving the wafer in the substantially vertical position to a predetermined location; and measuring one or more processing parameters from the wafer in the substantially vertical position at the predetermined location.

Implementations of the above aspect can include one or more of the following. The process can include inspecting the wafer for surface defects or accessing both surfaces of the wafer during wafer processing. The process can also include cleaning the wafer. The cleaning can include passing an air stream over the wafer to flush dry contaminated particles from the wafer; collecting the air stream with dislodged contaminated particles; trapping contaminated particles in a receptacle; and disposing the trapped contaminated particles through periodic preventive maintenance. The cleaning can also include forcing the air stream through the filter using an air pressure gradient; using an electrostatic filter to trap contaminated particles; and using a trap collection chamber to trap contaminated particles. The collection chamber can be either a gel or a sticking component. The process can include cleaning and replacing the trap collection chamber as part of periodic preventive maintenance. The filtering of the air stream can be accomplished using an air filter. The wafer can be retrieved from a top-most wafer to the bottom-most wafer to prevent particles on a bottom side of a dirty wafer from falling onto a cleaned wafer.

In yet another aspect, a wafer platform in a surface defect inspection system for inspection of both flat wafer surfaces positioned at the desired wafer orientation for the measurement device. Another aspect of the invention uses the multi-axis vertical wafer platform in a cluster measurement module format allowing multiple third party measurements modules to be attached and the desire measurement face of the wafer is reposition to that module.

In yet another aspect, a multi-axis vertical wafer platform positions a wafer in a substantially vertical manner so that the wafer's face sides can be rotated. The platform holds the wafer by standing on its round edges. The wafer is held on its round edges, using edge gripping mounts. The flat surfaces of the wafer is not facing up or down and is set to or can be adjusted to a specific angle other than horizontal. The wafer is moved to and away from the desired location and orientation by a positioning system. The wafer is oriented such that one or both flat wafer surfaces is accessible to other devices. For example, the wafer face can be moved to a focus position of the measurement module controlled by the measurement module. The wafer can be cleaned, inspected for surface defects, or accessed or processed using the vertical wafer platform.

In another aspect, a vertical wafer platform holds a wafer on its round edge can be reposition for pre-alignment in reference to the wafer's notch within the wafer holder if required. The wafer can be held into place using methods of edge gripping in the vertical plane by mechanical, pneumatics, vacuum, air, or combination of said methods, or any other suitable means. The wafer can be cleaned, inspected for surface defects, or accessed or processed using the vertical wafer platform.

In another aspect, a wafer platform holds the wafer on its round edges using edge gripping mounts. The flat surfaces of the wafer are not facing up or down and are set to or can be adjusted to a specific angle other than horizontal. The wafer is moved to and away from the desired location and orientation by a positioning system, and the wafer is oriented such that one or both flat wafer surfaces are accessible to other devices.

In yet another aspect, a method is disclosed for accessing and processing the flat surfaces of the wafer wherein the wafer is edge gripped exposing both sides; the wafer is held vertically and supported by its edges; the wafer is moved to the desired location by a positioning system; and the wafer is held at the desired location to the wafer processing device.

In another aspect, a method of cleaning a wafer includes passing filtered air stream over the wafer to flush dry contaminated particles off the dry wafer; collecting the air stream with dislodged contaminated particles off the wafer; trapping contaminated particles in a receptacle and passing decontaminated air stream; and disposing the trapped contaminated particles through periodic preventive maintenance of the unit.

Implementations of the above aspect may include using an electrostatic filter by forcing air stream through the filter using air pressure gradient; using an electrostatic filter to trap contaminated particles; and using a trap collection chamber that could consist of “gel” or similar “sticky solution” type sticking component to trap contaminated particles. The cleaning and replacing the trap collection chamber can be done as part of periodic preventive maintenance. The filtering of the air stream can use filters such as HEPA and ULPA, electrostatic filter and combination thereof. The wafers in the wafer holder can be retrieved from the topmost wafer to the bottommost wafer, preventing particles on the bottom side of dirty wafers from falling on freshly cleaned wafers. The system can be used to clean objects or environment near the wafer that has contaminated particles.

Advantages of the system may include one or more of the following. The system provides a vertical wafer platform for cleaning and inspection of wafer surfaces. By holding the wafer in a vertical position on its round edges such that the flat surfaces face left and right, the wafer surface is least susceptible to falling contaminated particles. Another benefit is both flat wafer surfaces or single surface are accessible to other devices, such as a wafer particle cleaner or a surface defect inspector, metrology measurement modules, among others. The ability to clean and/or inspect both sides of the wafer at the same time reduces process time. The ability to make all or majority of the necessary measurements in one unit also reduces process time, by allowing up to 6 axis of motion of wafer positioning.

Other advantages may include the following. The system provides quick access to both flat surfaces of the wafer at the desired wafer orientation for third party tools. The system also provides the ability to access and/or clean and/or inspect and/or process both flat wafer surfaces at the same time or sequentially without removing the wafer and re-inserting the wafer again with the measurement face switched. The system can perform a plurality of measurements without having to remove the wafer and insert it into another measurement system. The system removes airborne particles present in the measurement environment transferred from other systems. The system also purges the air should wafer breakage occurs to minimize creating more airborne particles that can electrostatically attach to the wafer. The system allows access to both sides of the wafer surface by holding the wafer on its edge.

### BRIEF DESCRIPTION OF THE DRAWINGS

The system will be readily discerned from the following detailed description of an exemplary embodiments thereof especially when read in conjunction with the accompanying drawing in which like parts bear like numerals throughout the several views.

FIG. 1 is one embodiment of a wafer particle cleaner.

FIG. 2 is an exemplary flow chart illustrating a method of cleaning a wafer.

FIG. 3A is an exemplary wafer particle cleaner with horizontally held wafer according to the invention.

FIG. 3B is another exemplary wafer particle cleaner with vertically held wafer.

FIGS. 4A-4B show another vertical wafer platform and an expanded view of the wafer holder tray, respectively.

FIG. 5 shows an exemplary process for transferring wafers.

### DESCRIPTION

The following detailed description refers to the accompanying drawings, which form a part hereof, and shows by way of illustration specific embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the invention is defined only by the appended claims.

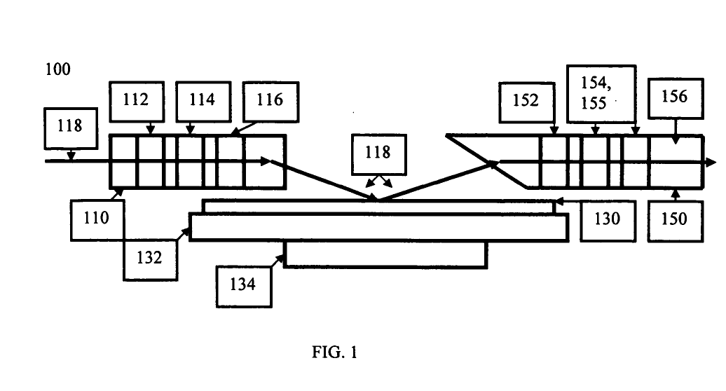

FIG. 1 is an example of the wafer particle cleaner 100. Cleaner 100 includes air intake unit 110, wafer 130, and air outlet unit 150. Air intake unit 110 includes a fan or a blower 112, a filter 114 and an ionizer 116. The location of air intake unit 110 can be anywhere in cleaner 100. Blower 112 is orientated in a way such that when operated, it draws outside air 118 and forces air 118 through filter 114 and ionizer 116 over the wafer 130. Filter 114 is an ultra low penetration air (ULPA) filter, or a high efficiency particle air (HEPA) filter, or an electrostatic filter, or any other type of filter suitable to trap microscopic airborne particles. Ionizer 116 adds and removes electrostatic charge to air 118. Ionizer 116 helps repel particles on the surfaces of wafer 130 or is used to neutralize the electrostatic charge on wafer 130.

Air 118 can be air, nitrogen, or any other type of non-corrosive gases suitable in a wafer production facility. Air 118 is at the same or at substantially similar temperature and relative humidity as wafer 130. Air 118 is typically unheated and low in relative humidity. Air stream 118 from air intake unit 110 can flow at various angles incident to the flat surfaces of wafer 130. In one embodiment, air stream 118 from air intake unit 110 flows parallel to the flat surfaces of wafer 130.

Wafer 130 is held in a wafer holder 132. Wafer holder 132 is received in wafer mount unit 134. In one embodiment, wafer 130 is preferably placed vertically in wafer holder 132 to minimize accumulation of particles after cleaning. In another embodiment, wafer 130 is more typically placed horizontally in wafer holder 132. Wafer mount unit 134 is configurable or adaptable to receive different kinds of wafer holders 132. In one embodiment, wafer holder 132 holds a single wafer. In another embodiment, wafer holder 132 holds more than one or multiple wafers.

Air outlet unit 150 includes a vacuum or fan 152, a filter 154, an ionizer 155 and an exhaust 156. In general, the location of air outlet unit 150 can be anywhere in cleaner 100. A vacuum 152 is orientated in a way such that when operated, it draws air 118 off the wafer 130 and forces air 118 through filter 154, ionizer 155 and exhaust 156. Filter 154 is an ultra low penetration air (ULPA) filter, or a high efficiency particle air (HEPA) filter, or an electrostatic filter, or any other type of filter suitable to trap microscopic airborne particles. Ionizer 155 is used to de-ionize air 118. Exhaust 156 allows the air 118 to leave the cleaner 100.

In operation, air intake unit 110 draws outside air 118 and forces the air through filter 114 and ionizer 116 and to the wafer 130. Filter 114 removes dirt or airborne particles in air 118 to produce the filtered air stream. Ionizer 116 adds or removes electrostatic charge to the filtered air stream. The filtered air stream passes by surfaces of wafer 130 and carries off particles on the surfaces of wafer 130 by air flow and electrostatic charge. An air outlet unit 150 sucks the air 118 off the wafer 130 and forces the air through filter 154 and ionizer 155 and exits cleaner 100 through the exhaust 156. Filter 154 and ionizer 155 remove dirt or airborne particles and neutralize electrostatic charge of air 118 to produce de-ionized, filtered exhaust air.

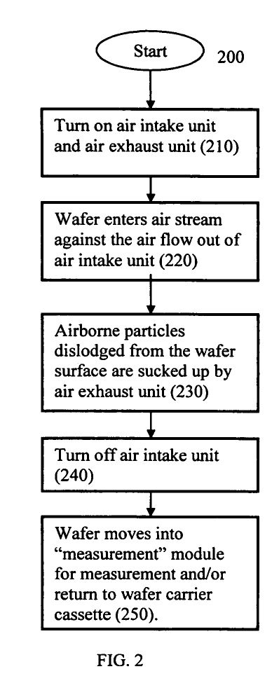

FIG. 2 is an exemplary flow chart illustrating a method 200 according to the invention. In general, method 200 describes a method of cleaning a semiconductor wafer by passing ionized filtered air stream by the wafer. The air intake unit and air exhaust unit are turned on—the air intake unit draws outside air while the air stream is filtered and ionized (210). Next, the wafer enters the air stream from the direction against the flow of air stream coming out of air intake unit (220). The filtered air stream hits the wafer to carry away the particles from the surfaces of the wafer and is sucked up by air exhaust unit (230). The air intake unit is then turned off (240). The cleaned wafer is moved into a measurement module and/or returned to wafer carrier cassette (260).

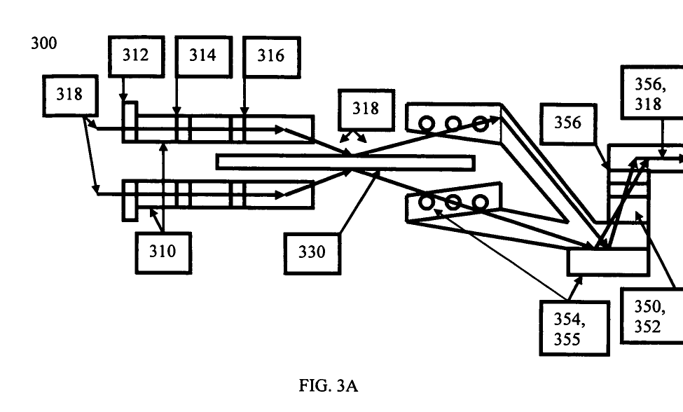

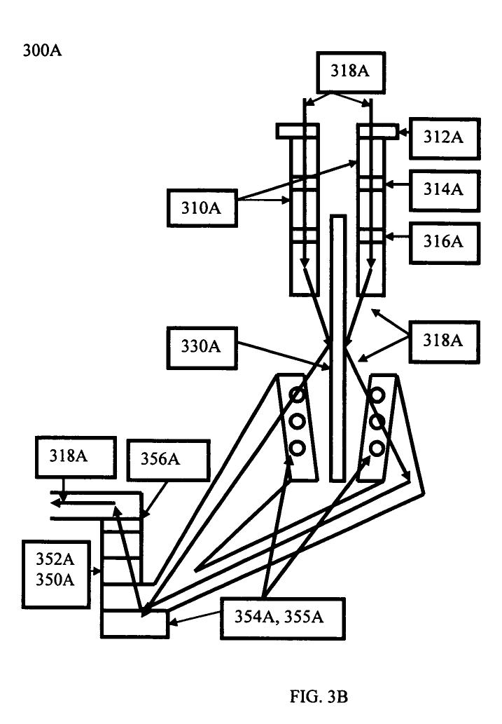

FIG. 3A shows another embodiment of a wafer cleaner, in this case wafer particle cleaner 300 with a horizontally held wafer. Cleaner 300 includes air intake unit 310, wafer 330, and air outlet unit 350. Air intake unit 310 includes a fan or a blower 312, a filter 314 and an ionizer 316. At least one air intake unit 310 is located above wafer 330. At least one air intake unit is located below wafer 330. Blower 312 is orientated in a way such that when operated, it draws outside air 318 and forces air 318 through filter 314 and ionizer 316 over (or under) the wafer 330. Filter 314 is an ultra low penetration air (ULPA) filter, or a high efficiency particle air (HEPA) filter, or an electro-static filter, or any other type of filter suitable to trap microscopic airborne particles. Ionizer 316 adds and removes electrostatic charge to air 318. Ionizer 316 helps repel particles on the surfaces of wafer 330 or is used to neutralize the electrostatic charge on wafer 330.

Air 318 can be air, nitrogen, or any other type of non-corrosive gases suitable in a wafer production facility. Air 318 is at the same or at substantially similar temperature and relative humidity as wafer 330. Air 318 is typically unheated and low in relative humidity. Air stream 318 from air intake unit 310 can flow at various incidence angles to the flat surfaces of wafer 330. In one embodiment, air stream 318 from air intake unit 310 flows parallel to the flat surfaces of wafer 330. Wafer 330 is held in a wafer holder 332. Wafer 330 is held horizontally in wafer holder 332. Air outlet unit 350 includes a vacuum or fan 352, a filter 354, an ionizer 355 and an exhaust 356. At least one in outlet unit 350 is located above the wafer 330. At least one air outlet unit 350 is located below the wafer 330. A vacuum 352 is orientated in a way such that when operated, it draws air 318 off the wafer 330 and forces air 318 through filter 354, ionizer 355 and exhaust 356. Filter 354 is an ultra low penetration air (ULPA) filter, or a high efficiency particle air (HEPA) filter, or an electrostatic filter, or any other type of filter suitable to trap microscopic airborne particles. Ionizer 355 is used to de-ionize air 318. Exhaust 356 allows the air 318 to leave the cleaner 300.

In operation, cleaner 300 cleans both sides of wafer 330 at the same time or sequentially. Air intake units 310 draw outside air 318 and force the air through filter 314 and ionizer 316 and to the wafer 330. Filter 314 removes dirt or airborne particles in air 318 to produce the filtered air stream. Ionizer 316 adds or removes electrostatic charge to the filtered air stream. The filtered air stream passes by surfaces of wafer 330 and carries off particles on the surfaces of wafer 330 by air flow and electrostatic charge. Air outlet units 350 suck the air 318 off the wafer 330 and force the air through filter 354 and ionizer 355 and exits cleaner 300 through the exhaust 356. Filter 354 and ionizer 355 remove dirt or airborne particles and neutralize electrostatic charge of air 318 to produce de-ionized, filtered exhaust air.

FIG. 3B shows another embodiment with a wafer particle cleaner 300A having vertically held wafers. Cleaner 300A includes air intake unit 310A, wafer 330A, and air outlet unit 350A. Air intake unit 310A includes a fan or a blower 312A, a filter 314A and an ionizer 316A. At least one air intake unit 310A is located on the right side of (or above) wafer 330A. At least one air intake unit is located on the left side of (or below) wafer 330A. Blower 312A is orientated in a way such that when operated, it draws outside air 318A and forces air 318A through filter 314A and ionizer 316A on the wafer 330A. Filter 314A is an ultra low penetration air (ULPA) filter, or a high efficiency particle air (HEPA) filter, or an electro-static filter, or any other type of filter suitable to trap microscopic airborne particles. Ionizer 316A adds and removes electrostatic charge to air 318A. Ionizer 316A helps repel particles on the surfaces of wafer 330A or is used to neutralize the electrostatic charge on wafer 330A.

Air 318A can be air, nitrogen, or any other type of non-corrosive gases suitable in a wafer production facility. Air 318A is at the same or at substantially similar temperature and relative humidity as wafer 330A. Air 318A is typically unheated and low in relative humidity. Air stream 318A from air intake unit 310A flows at various incidence angles to the flat surfaces of wafer 330A. In one embodiment, air stream 318A from air intake unit 310A flows parallel to the flat surfaces of wafer 330A.

Wafer 330A is held in a wafer holder 332A. Wafer 330A is held vertically in wafer holder 332A. The wafer holder can be an edge gripper robot arm, or paddle, or a wafer holder that supports and holds the wafer at the edges.

Air outlet unit 350A includes a vacuum or fan 352A, a filter 354A, an ionizer 355A and an exhaust 356A. At least one in outlet unit 350A is located on the right side of (or above) the wafer 330A. At least one air outlet unit 350A is located on the left side of (or below) the wafer 330A. A vacuum 352A is orientated in a way such that when operated, it draws air 318A off the wafer 330A and forces air 318A through filter 354A, ionizer 355A and exhaust 356A. Filter 354A is an ultra low penetration air (ULPA) filter, or a high efficiency particle air (HEPA) filter, or an electrostatic filter, or any other type of filter suitable to trap microscopic airborne particles. Ionizer 355A is used to de-ionize air 318A. Exhaust 356A allows the air 318A to leave the cleaner 300A.

In operation, cleaner 300A cleans both sides of wafer 330A at the same time and vertically held wafer 330A help keep the dirt off wafer surfaces after cleaning. Air intake units 310A draw outside air 318A and force the air through filter 314A and ionizer 316A and to the wafer 330A. Filter 314A removes dirt or airborne particles in air 318A to produce the filtered air stream. Ionizer 316A adds or removes electrostatic charge to the filtered air stream. The filtered air stream passes by surfaces of wafer 330A and carries off particles on the surfaces of wafer 330A by air flow and electrostatic charge. Air outlet units 350A suck the air 318A off the wafer 330A and force the air through filter 354A and ionizer 355A and exits cleaner 300A through the exhaust 356A. Filter 354A and ionizer 355A remove dirt or airborne particles and neutralize electrostatic charge of air 318A to produce de-ionized, filtered exhaust air.

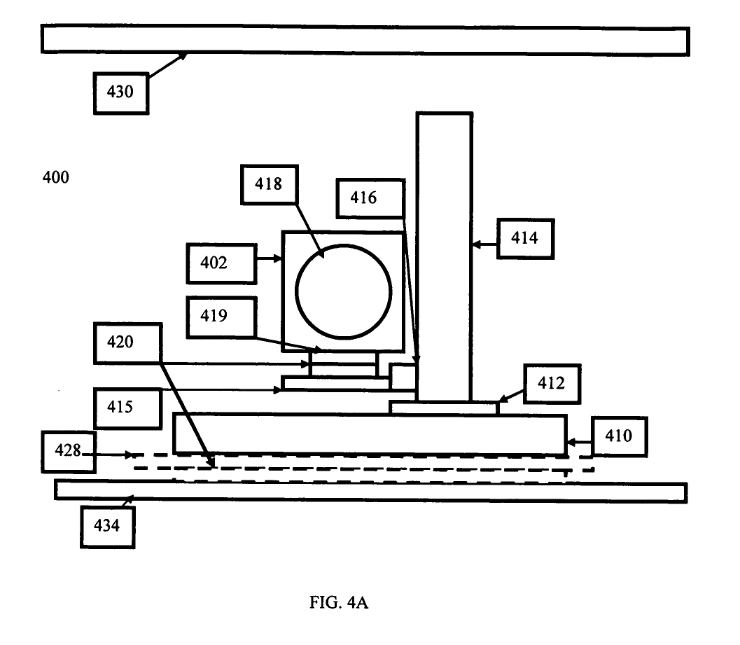

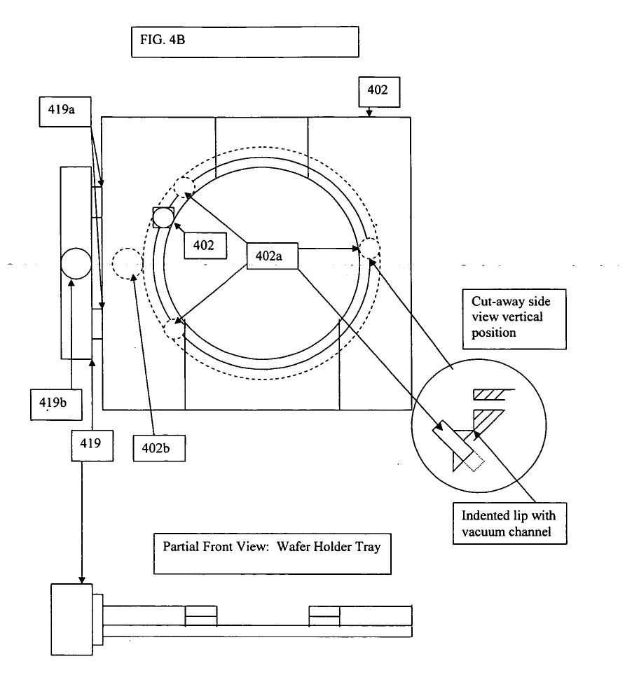

FIGS. 4A-4B show another platform embodiment, in this case a vertical wafer platform 400. System 400 holds the wafer 418 in a vertical position such that the wafer 418 stands on its round edges. The wafer 418 is held on by edge supported gripper 402. The wafer holder 402 is a tray with an outer ring that is that is “slightly” larger in size of the desire wafer size diameter with the inner ring removed to form a hole. If the robot handling system provides wafer pre-alignment, centering, prior to transfer to the wafer holder tray, the outer ring diameter can be reduced to almost the size of the wafer itself. A wafer holder tray with adjustable ends is an alternative design concept to reduce the clearance between the wafers edge and the edge of the wafer holder tray slot itself providing a tighter hold of the wafer where after the wafer is deposited, one end or both contracts to the wafer wafer's edge. The allowable distance from the outer ring to the inner ring is an “edge exclusion” that is allowable for the wafer. This wafer holder tray will provide the stiffness required to reduce the vibration upon wafer repositioning. Within the edge exclusion ring of the tray is a vacuum system to hold the wafer into place with addition edge grip at its opposite site to hold it in place through either mechanical means, or pneumatic, or constant air pressure pressing against it. The wafer holder at the outer ring is indented inward to allow the wafer's edge to sit on its edge in the vertical position. In one implementation, the wafer tray can be positioned horizontally when the wafer from a wafer transfer system, for robot with a arm that grabs and transfer the wafer with the wafer in the horizontal position, and upon completion of the wafer transfer and the wafer is secured, it rotates to the vertical position; or the tray can be in the vertical position for wafer transfer, for robots with arm that can rotate the wafer in the vertical position. The wafer holder tray is slotted to allow for either type of robot arm transfer system, edge grip type of multiple axis of control or straight arm paddle type. System 400 moves the vertically held wafer to the desired position in space by mechanical, electrical, pneumatic or any other suitable moving mechanisms 410, 412, 414, and 416, and to the desired orientation in space by any suitable moving mechanisms 415, 419, and 420. Item 415 allows the wafer holder tray with wafer to be rotated from the horizontal position to any desire position toward vertical and hold it in that position. Item 420 is a motorized rotor unit to allow for the rotation of the wafer face to any desire position. Item 419 is a block with a set of slides (419a), attached to the base of the wafer holder tray 402, with a motor (419b) moving the wafer holder tray holding the wafer with its measurement face to a desire focus position referencing the measurement module and its requirements. Item 419, 420, and 402 are held together as a stack unit being rotate-able by item 415. The desired positioning of the wafer can be control through the vision processing unit of the third party measurement unit, or their pre-program destination based upon where the third party control unit and their required measurement site. The orientation of the wafer is provided through the wafer holder tray by a motor 402a rotating the ring holding the wafer. The mechanized units of 415 and 420 can be encoded to provide correct positional orientation and control. The mechanism of item 419 can be controlled by the third party measurement module electronics' in a close-loop feedback system for focusing positioning. If lateral and Z movement positioning is required at all measurement modules, item 420 can also be place underneath the plate, item 428, supporting the motion system and be able to rotate the whole unit with the additional option of it between items 419 and 420. This design provides the user with 6 axis of motion.

Wafer 418 is kept clean by an optional downward filtered laminar airflow 430 that passes over the wafer 418. Exhaust airflow is collected through the openings in the base 434. In one arrangement, filtered laminar flow 430 is parallel to the wafer surfaces, and passes between the wafer surface and the measurement module.

The vertical wafer platform collects fewer falling particles compared to a horizontally held wafer. Additionally, the vertical wafer platform provides the ability to purge the air within the measurement module preventing turbulent airflow within the measurement chamber. Further, the measurement modules are not top mounted over the wafer 418 so falling particles from the measurement modules do not accumulate on the wafer surfaces or at the base of the measurement chamber. Moreover, both flat surfaces of wafer 418 are accessible at the same time by any other devices in one orientation. The wafer face can be rotated to face other third party measurement devices for measurement by the suitable moving mechanism 420.

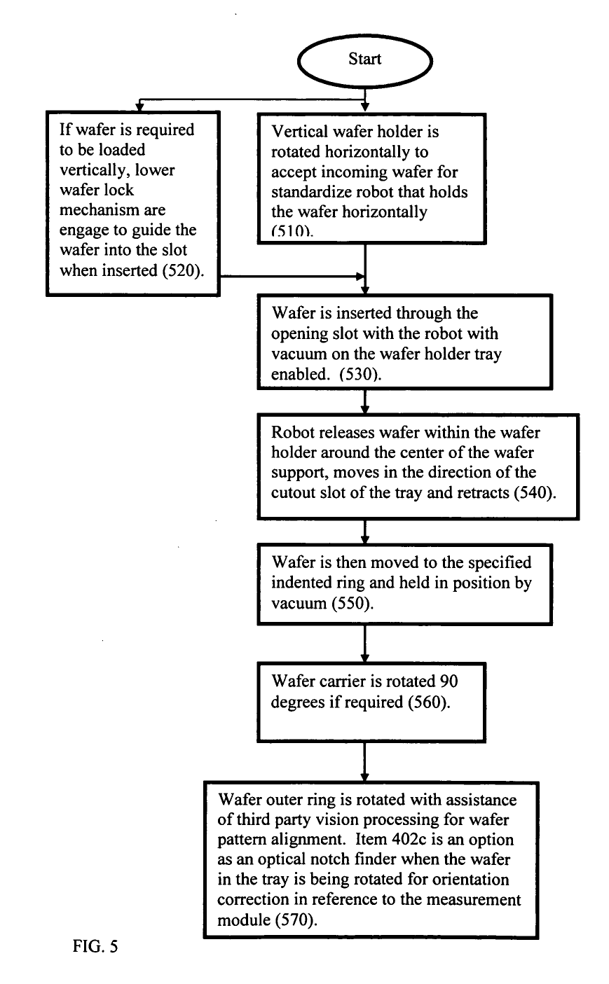

FIG. 5 shows an exemplary wafer transfer flow chart. Typically, wafers arrive at the station stacked in cassettes, and a robot removes the wafers from the cassette one at a time for testing. In many testing procedures, the wafers are placed on a stage with six degrees of freedom by the robot. The stage accurately positions the wafer with respect to an inspection/testing apparatus which performs measurements at precisely defined points on the wafer. Examples of inspection/testing procedures include thin film quality and thickness measurements, stress measurements, or other measurements. At a robotic station, several cassettes are often used. For example, there may be a cassette for incoming wafers, a cassette for outgoing wafers, and a cassette for flawed wafers. The robot moves wafers among all the cassettes as well as the stage.

Turning now to FIG. 5, first, the vertical wafer holder is rotated horizontally to accept incoming wafer for a conventional robot that holds the wafer horizontally (510). Alternatively, the process determines if a wafer needs to be loaded vertically and if so lower wafer lock mechanisms are engaged to guide the wafer into the slot when inserted in (520).

From 510 or 520, the wafer is inserted through the opening slot with the robot with vacuum on the wafer holder tray enabled (530). With wafer pre-aligned prior to insertion, placement error is minimized. Next, Robot releases wafer within the wafer holder around the center of the wafer support, moves in the direction of the cutout slot of the tray and retracts out (540). Wafer is then moved to the specified indented ring and held in position by vacuum (550). Wafer carrier is rotated 90 degrees (item 415) if required (560). Wafer outer ring is rotated (item 402b) with assistance of third party vision processing for wafer pattern alignment (570). Item 402c is an option as an optical notch finder when the wafer in the tray is being rotated for orientation correction in reference to the measurement module.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the aforegoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

What is claimed is:

1. A multi-axis vertical wafer platform, comprising:
a. a measurement module in a semiconductor processing chamber, the measurement module having a focus position to collect data from the wafer;
b. means for gripping a wafer at a wafer edge; and
c. means for positioning the gripped wafer from a horizontal orientation to a non-horizontal orientation at the focus position to allow access to one or both wafer surfaces, the positioning means providing a plurality of degrees of freedom to move the wafer to the focus position.

2. The platform of claim 1, wherein the non-horizontal orientation comprises a substantially vertical orientation.

3. The platform of claim 1, wherein the wafer has a reference notch and wherein the wafer is positioned for pre-alignment in reference to the reference notch.

4. The platform of claim 1, wherein the wafer is housed in a wafer holder.

5. The platform of claim 1, wherein the wafer is edge gripped using one of: mechanical, pneumatics, vacuum, and air mechanisms.

6. The system of claim 1, comprising means for cleaning a wafer.

7. The system of claim 1, comprising means for inspecting a wafer for surface defects.

8. The system of claim 1, comprising means for accessing or processing one or more surfaces of the wafer.

9. The system of claim 1, wherein the means for gripping comprises one or more edge gripping mounts.

10. The system of claim 1, wherein both wafer surfaces are accessible to other devices in the processing chamber at the same time.

11. The system of claim 1, wherein the positioning means comprises that the whole multi-axis stage assembly securing the wafer in the vertical position to be able to rotate and orient the desire face of the wafer facing the desire measurement module.

12. A vertical wafer platform, comprising:
a. a processing module in a semiconductor processing chamber, the processing module having a focus position to process the wafer;
b. one or more edge gripping mounts to grip a wafer edge; and
c. a multi-axis positioner to move the gripped wafer in a non-horizontal orientation to the focus position to allow access to one or both wafer surfaces.

13. The platform of claim 12, wherein the non-horizontal orientation comprises a substantially vertical orientation.

14. A method for processing a wafer, comprising:
gripping an edge of the wafer and moving the wafer to a substantially vertical position;
moving the wafer in the substantially vertical position with a multi-axis positioner to a predetermined location; and
measuring one or more processing parameters from the wafer in the substantially vertical position at the predetermined location.

15. The method of claim 14, comprising inspecting the wafer for surface defects.

16. The method of claim 14, comprising accessing both surfaces of the wafer during wafer processing.

17. The method of claim 14, comprising cleaning the wafer.

18. The method of claim 17, comprising:
passing an air stream over the wafer to flush dry contaminated particles from the wafer;
collecting the air stream with dislodged contaminated particles;
trapping contaminated particles in a receptacle; and
disposing the trapped contaminated particles through periodic preventive maintenance.

19. The method of claim 17, comprising:
forcing the air stream through the filter using an air pressure gradient;
using an electrostatic filter to trap contaminated particles; and
using a trap collection chamber to trap contaminated particles.

20. The method of claim 19, wherein the collection chamber comprises one of: a gel, a sticking component.

21. The method of claim 19, comprising cleaning and replacing the trap collection chamber as part of periodic preventive maintenance.

22. The method of claim 17, comprising filtering the air stream using an air filter.

23. The method of claim 17, wherein the wafer is retrieved from a top-most wafer to the bottom-most wafer to prevent particles on a bottom side of a dirty wafer from falling onto a cleaned wafer.
